(19) United States
(12) Patent Application Publication
(10) Pub. No.: US 2014/0132787 A1
(43) Pub. Date: May 15, 2014

(54) Motion Detection Device and Motion Detection Method Having Rotation Calibration Function

(71) Applicant: Chun-Huang Lin, Hsinchu City (TW)

(72) Inventor: Chun-Huang Lin, Hsinchu City (TW)

(73) Assignee: Chip Goal Electronics Corporation

(21) Appl. No.: 13/677,164

(22) Filed: Nov. 14, 2012

(51) Int. Cl. H04N 5/232

(52) U.S. Cl. CPC H04N 5/232
USPC 348/211.99

(57) ABSTRACT

The present invention provides a motion detection device and a motion detection method having a rotation calibrating function. The motion detection device detects a relative motion of a DUD (device under detection) with respect to a reference light source. The motion detection device includes a rotation sensor, an image sensor, and a coordinate transfer unit. The rotation sensor is disposed on the DUD for detecting rotation of the DUD to generate rotation information. The image sensor captures an image generated by the reference light source, to obtain an absolute coordinate according to a coordinate system related to the image sensor. The coordinate transfer unit calibrates the absolute coordinate according to the rotation information to generate a calibrated coordinate.

### BACKGROUND OF THE INVENTION

1. Field of Invention

The present invention relates to a motion detection device and method having a rotation calibration function, especially a motion detection device and method using a gravity sensor or other means to assist calculating a relative motion of a DUD (device under detection) with respect to a reference light source.

2. Description of Related Art

Recently many electronic interactive systems provide users with a joystick or remote controller such that the users can operate the joystick or remote controller for various actions which can be sensed by the systems, wherein a relative motion of the remote controller or joystick is calculated with respect to a reference light source.

FIG. 1 shows a prior art optical indicator control system 10. The indicator for example is a cursor or a controlled object on a screen. An image analyzing unit 121 is provided in the remote controller 12, to capture an image frame including a light image generated from a reference light source 11. When the remote controller 12 changes its position, the position of the light image sensed by the image analyzing unit 121 also changes; thus, the relative motion such as the displacement of the remote controller 12 with respect to the reference light source 11 can be calculated.

However, when a user holds the remote controller 12, the remote controller 12 is not necessarily in a horizontal position with respect to the reference light source 11. The user usually grips the remote controller 12 by a certain habitual rotation angle; such rotation angle can cause a misjudgment of the image analyzing unit 121 to determine the motion of the received image. The direction of the relative motion of the received image is changed due to the rotation angle. For example, the remote controller actually moves horizontally with respect to ground, but the user holds the controller 12 by a rotation angle, so the image of the reference light source 11 received by the image analyzing unit 121 moves along an oblique direction, and causes a misjudgment. Although, the user can carefully control the controller 12 to avoid this misjudgment, this is inconvenient to the user and greatly reduces the fun of an interactive operation.

In view of the above, the present invention provides a motion detection device, which has the benefits of simple design and easy control, especially advantageous in that it is capable of calculating the motion of a device under detection (DUD) when the DUD rotates at some angle.

### SUMMARY OF THE INVENTION

The present invention provides a motion detection device and method having a rotation calibration function. The motion detection device detects a relative motion of a DUD with respect to a reference light source; it includes a rotation sensor, an image sensor, and a coordinate transfer unit. The rotation sensor is disposed in the DUD for detecting rotation of the DUD to generate rotation information. The image sensor captures an image generated by the reference light source, to obtain an absolute coordinate according to a coordinate system related to the image sensor. The coordinate transfer unit calibrates the absolute coordinate according to the rotation information to generate a calibrated coordinate.

In one embodiment of the motion detection device, the rotation sensor can include a gravity sensor, a gyro-sensor, or an e-compass.

In another preferable embodiment of the present invention, the motion detection device can calculate a displacement according to absolute coordinates or calibrated coordinates of the DUD before and after a movement of the DUD.

In the aforementioned motion detection device, the image sensor is disposed inside the DUD, and the reference light source is disposed outside the DUD; or, the image sensor is disposed outside the DUD, and the reference light source is disposed inside the DUD.

The DUD can further include a vibration motor, a voice control device, or an audio generation device which is disposed in the motion detection device.

In a preferable embodiment of the present invention, the reference light source includes a light emitting device and an optical lens. The optical lens modifies the light path from the light emitting device to increase the view angle of the reference light source.

From another perspective, the present invention provides a detection method having a rotation calibrating function, for detecting a relative motion of a DUD with respect to a reference light source, the detection method includes: detection a rotation of the DUD to generate rotation information; mapping a light spot received from the reference light onto a coordinate system to obtain an absolute coordinate; and calibrating the absolute coordinate according to the rotation information to generate a calibrated coordinate

In case it is required, the calibrated coordinate can be further transformed into a coordinate with respect to another coordinate system.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art optical indicator control system.

FIG. 2 shows a preferable embodiment of the motion detection device according to the present invention.

FIG. 3 shows rotations of the DUD.

FIG. 4 shows the projected components of the gravity sensed by the gravity sensor.

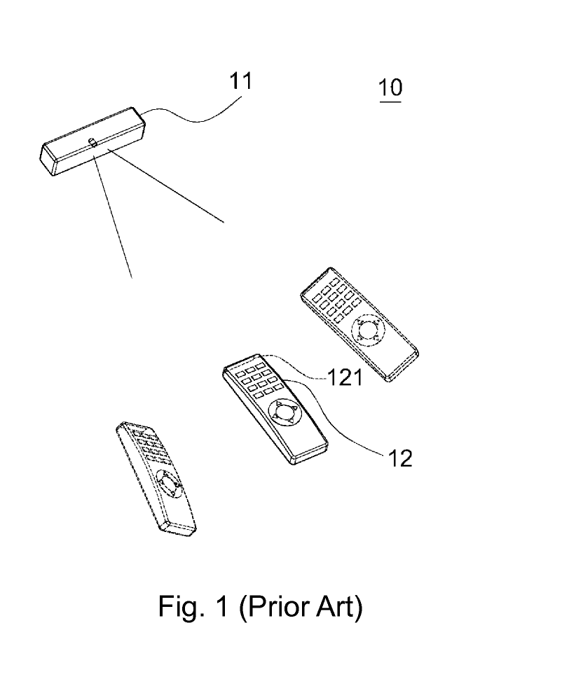

### DESCRIPTION OF THE PREFERRED EMBODIMENTS

The drawings as referred to throughout the description of the present invention are for illustrative purpose only, but not drawn according to actual scale. The orientation wordings in the description such as: above, under, left, and right are for reference with respect to the drawings, but not for limiting the actual product made according to the present invention.

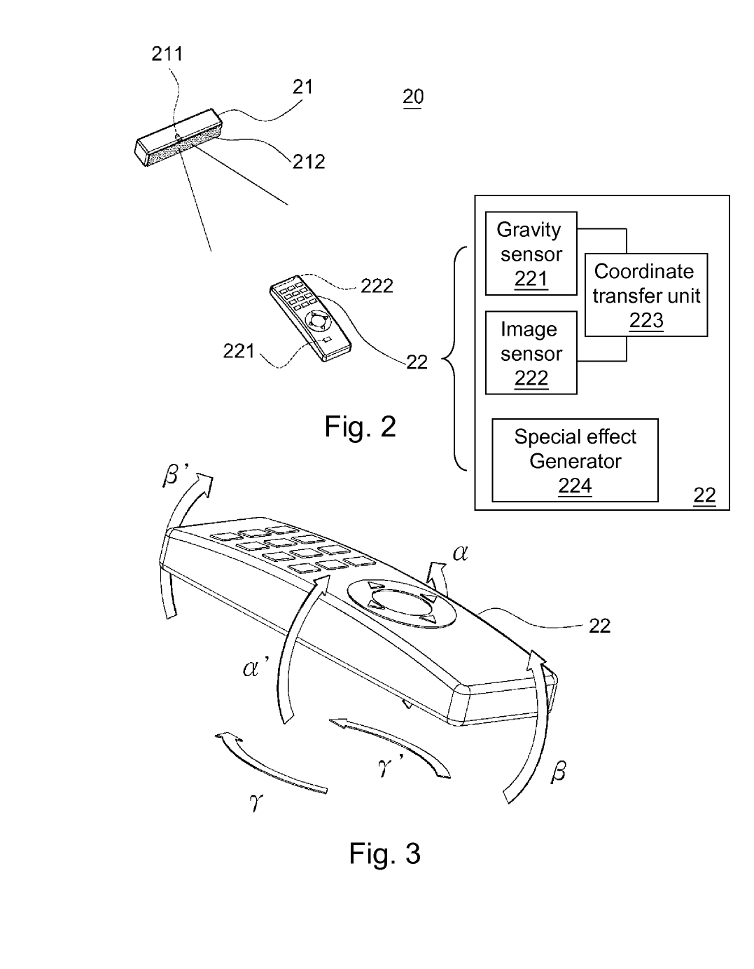

Referring to FIG. 2, wherein a motion detection device 20 according to the present invention is shown. The motion detection device 20 detects a relative motion of the DUD 22 with respect to a reference light source 21. The motion detection device 20 includes a rotation sensor (such as a gravity sensor 221 in this embodiment), an image sensor 222, and a coordinate transfer unit 223. The gravity sensor 221 for example can be, but not limited to, a CMOS image sensor, and the coordinate transfer unit 223 for example can be, but not limited to, a microprocessor.

The gravity sensor 221 is disposed in the DUD 22 and detects the rotations of the DUD 22 (referring to labels α [symbol] α′ [symbol] β [symbol] β40 [symbol] Y [symbol] y′ shown in FIG. 3) to generate rotation angle information. In this embodiment, the reference light source 21 is disposed outside the DUD 22 and the image sensor 222 is disposed inside the DUD 22. The image sensor 222 captures an image frame which includes a light image generated by the reference light source 21, to obtain an absolute coordinate (or coordinates) with respect to a coordinate system related to the image sensor 222. For example, the image sensor 222 includes a coordinate system, and the complete image frame captured by the image sensor 222 is mapped to this coordinate system. A light image such as a light spot generated by the reference light source 21 has a location on this coordinate system, occupying one or more pixels. If the location occupies one pixel, the coordinate of the pixel can be defined as the absolute coordinate. If the location occupies more than one pixel, a representative value of the pixels can be defined as the absolute coordinate, such as, for example, the coordinate of a representative pixel, the coordinate of a center of the plural pixels, the coordinate of a gravity center of the plural pixels, etc.

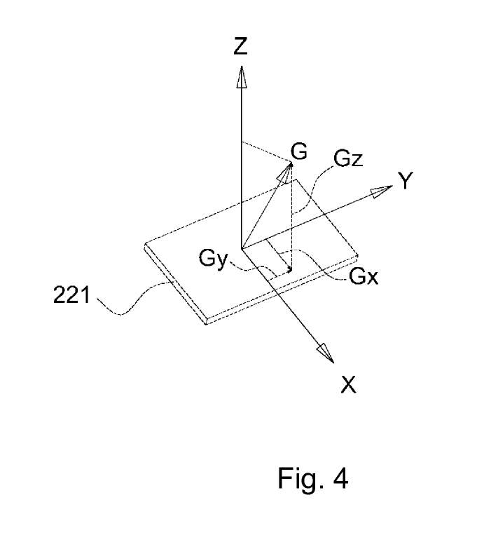

Referring to FIG. 4, the gravity sensor 221 senses the gravity G, that is, it senses the components Gx, Gy, and Gz of the gravity G projected in three dimensions X, Y, and Z, respectively. Based on the variations of the projected components Gx, Gy, and Gz, the system can analyze the rotation angle of the DUD, to generate related rotation information.

The coordinate transfer unit 223 calibrates the absolute coordinate to generate a calibrated coordinate according to the absolute coordinate obtained from the image sensor 223 and the rotation information from the gravity sensor 221.

In case it is required, the coordinate transfer unit 223 can further transform the calibrated coordinate into a coordinate with respect to another coordinate system. For example, the calibrated coordinate can be complying with the resolution of the coordinate system related to the image sensor resolution, while the transformed coordinate can be complying with the resolution of a coordinate system related to a display device (not shown). Of course, the coordinate transfer unit 223 can transform the calibrated coordinate according to other requirements not limited to the above.

The DUD 22 for example can be but not limited to a remote controller or joystick; when the user moves the DUD 22, the light image from the reference light source 21 which is captured by the image sensor 222 will move correspondingly. The motion detection device 20 can calculate a displacement according to the coordinates (absolute coordinates or calibrated coordinates) before and after the movement of the DUD. This displacement can be applied to generating control information, such as controlling a cursor movement of a display device (not shown in figures), or controlling an action of a game character. The motion detection device 20 can communicate with the display device by wired or wireless manner.

Because the coordinate and displacement are determined by the relative relationship between the reference light source 21 and the image sensor 222, the dispositions of the reference light source 21 and image sensor 222 are interchangeable. That is, the reference light source 21 can be disposed in the DUD 22 and the image sensor 222 can be disposed outside the DUD 22. The captured image by the image sensor 222 can be transmitted to the coordinate transfer unit 223 by wired or wireless communication. The coordinate transfer unit 223 can be disposed either inside the DUD 22 or outside the DUD 22.

The rotation information can be generated not only by the gravity sensor as described in the previous embodiments; any device which can generate rotation information such as a gyro-sensor or an e-compass, etc. can be used.

Besides, the motion detection device 20 can further include a special effect generator 224 inside the DUD 22, which is for example a vibration motor 224. When the DUD 22 receives a vibration command, the vibration motor causes the DUD 22 to vibrate to improve the interactive effect. For example, during playing an interactive game, when the user encounters an impact, a shock, a bumping road, etc, the vibration motor can increase the interactive fun.

The special effect generator 224 can be for generating other effects. For example, the motion detection device can further include a voice control device or an audio generation device, disposed inside the DUD. For example, the user can control the operation of the interactive system by the voice control device, to scroll pages on a screen or to enter a next game stage. The audio generation device can generate an audio effect, which for example can increase the sound field effect of a game, or to remind the user the location of the DUD 22 by an audio sound when use is looking for the DUD 22.

The reference light source 21 can be a spot light source, a linear light source, or a planar light source. In a preferable embodiment of the present invention, referring to FIG. 2, the reference light source 21 can include at least one light emitting device 211 and one optical lens 212. The optical lens 212 is disposed in front of the light emitting device 211 to change the light path from the light emitting device 211, for expanding the view angle of the reference light source 21. The optical lens 212 expands the view angle so that the light image can be sensed from a wider area.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the reference light source can emit light continuously or in pulses. It is not necessarily to use only one of the gravity sensor, gyro-sensor or e-compass; they can be used in combination, i.e., two or more of them can be used together. A circuit or device which does not affect the primary function of the overall system can be inserted between two circuit or devices shown to be in direct connection in the figures. An embodiment or a claim of the present invention does not need to attain or include all the objectives, advantages or features described in the above. The abstract and the title are provided for assisting searches and not to be read as limitations to the scope of the present invention. The scope of the present invention should cover all the variations and modifications within the spirit of the present invention.

What is claimed is:

1. A motion detection device having a rotation calibration function, for detecting a relative motion of a DUD (device under detection) with respect to a reference light source, the motion detection device comprising:
a rotation sensor, disposed in the DUD for detecting a rotation of the DUD to generate rotation information;
an image sensor, for capturing an image generated by the reference light source, to obtain an absolute coordinate with respect to a coordinate system related to the image sensor; and
a coordinate transfer unit, for calibrating the absolute coordinate according to the rotation information to generate a calibrated coordinate.

2. The motion detection device of claim 1, wherein the rotation sensor includes a gravity sensor, a gyro-sensor, or an e-compass.

3. The motion detection device of claim 1, wherein the motion detection device calculates a displacement according to absolute coordinates or calibrated coordinates of the DUD before and after a movement of the DUD.

4. The motion detection device of claim 1, wherein the image sensor is disposed inside the DUD, and the reference light source is disposed outside the DUD; or the image sensor is disposed outside the DUD, and the reference light source is disposed inside the DUD.

5. The motion detection device of claim 1, wherein the DUD includes a vibration motor, the vibration motor being disposed in the motion detection device.

6. The motion detection device of claim 1, wherein the DUD includes a voice control device or an audio generation device, the voice control device or the audio generation device being disposed in the DUD.

7. The motion detection device of claim 1, wherein the reference light source includes a light emitting device and an optical lens, the optical lens modifying the light path from the light emitting device to increase the view angle of the reference light source.

8. The motion detection device of claim 1, wherein the coordinate transfer unit further transforms the calibrated coordinate into a coordinate with respect to another coordinate system.

9. A motion detection method having a rotation calibration function, for detecting a relative motion of a DUD (device under detection) with respect to a reference light source, the motion detection method comprising:
detecting a rotation of the DUD to generate rotation information;
mapping a light spot received from the reference light onto a coordinate system to obtain an absolute coordinate; and
calibrating the absolute coordinate according to the rotation information to generate a calibrated coordinate.

10. The motion detection method of claim 9, wherein the rotation of the DUD is detected by a gravity sensor, a gyro-sensor, or an e-compass.

11. The motion detection method of claim 10, further comprising:
calculating a displacement according to absolute coordinates or calibrated coordinates of the DUD before and after a movement of the DUD.

12. The motion detection method of claim 10, further comprising:
transforming the calibrated coordinate into a coordinate with respect to another coordinate system.
